(19) United States
(12) Patent Application Publication
(10) Pub. No.: US 2003/0186770 A1
(43) Pub. Date: Oct. 2, 2003

(54) Varibale displacement oil hydraulic motor and crawler vehicle drive speed reducer using the same

(76) Inventors: Masaaki Kuma, Ishikawa (JP); Kenichi Kishi, Ishikawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/372,203

(22) Filed: Feb. 25, 2003

(30) Foreign Application Priority Data
Mar. 26, 2002 (JP) 2002-85815

(51) Int. Cl. F16H 47/04

(52) U.S. Cl. 475/83

(57) ABSTRACT

A variable displacement oil hydraulic motor designed to have its axial size minimized is disclosed, which comprises: a cylinder block receiving a plurality of pistons in pressure contact with a slanting surface of a swash plate variable in its angle of inclination, a motor housing accommodating the cylinder block therein; and at least one swash plate inclination changing piston which is disposed at a given circumferential position in an annular space defined between an outer periphery of the cylinder block and an inner periphery of the motor housing and which is movable bidirectionally in a direction parallel to the abovementioned pistons to alter the angle of inclination of the swash plate.

### BACKGROUND OF THE INVENTION

1. Field of the Invention

The present invention relates to a variable displacement oil hydraulic motor of axial piston type in which the rotational speed of its output shaft is varied by varying the angle of inclination of its swash plate to vary its piston stroke. The invention also relates to a crawler vehicle drive speed reducer using such a variable displacement oil hydraulic motor.

2. Description of the Prior Art

The prior art for a variable displacement oil hydraulic motor of this type and a crawler vehicle drive speed reducer using the same is exemplified by one shown in FIG. 7. As shown in the Figure, the variable displacement oil hydraulic motor indicated by reference character 1 has its output shaft 3 to which a reducer 2 is coupled. It is shown that the variable displacement oil hydraulic motor 1 and the reducer 2 together make up a crawler vehicle drive speed reducer. The reducer 2 has an out member 4 rotatably fitted over the outer periphery of a motor housing 6 of the variable displacement oil hydraulic motor 1 and having a driving wheel 5 of the crawler travel device fastened thereto.

The variable displacement oil hydraulic motor 1 also includes a cover member 7 that closes an opening end of the motor housing 6. The output shaft 3 is rotatably supported between an end wall 16 of the motor housing 6 and the cover member 7. A cylinder block 8 is fitted over the output shaft 3 rotatably therewith in the motor housing 6. A plurality of cylinders 9 are arranged in the cylinder block 8 about its axis, and a like plurality of pistons 10 are slidably fetted through these cylinders 9, respectively. A swash plate 11 has a slanting surface contacted by the leading ends of these pistons 10 for controlling the piston stroke for the variable displacement oil hydraulic motor 1. A pressure oil supply circuit 12 is included in the cover member 7 for supplying each of the cylinders 9 with pressure oil. A parking braking unit 13 is provided in a space between the inner peripheral surface of the motor housing 6 and the outer peripheral surface of the cylinder block 8.

The swash plate 11 is supported by a trunnion 14 so as to be inclined in a plane containing the axis of the output shaft 3 and has its angle of inclination variable from small to large. A swash plate inclination changing piston 15 for changing the angle of inclination of the swash plate 11 is positioned within the end wall 16 of the motor housing 6.

The output shaft 3 is supported at its one end by the cover member 7 and at its other end by the end wall 16 of the motor housing 6, via bearings 17 and 18, respectively. Further, because of different types of oil used as the operating oil for the variable displacement oil hydraulic motor 1 and the lubricating oil for the reducer 2, the output shaft 3 and the end wall 16 of the motor housing 6 are isolated from each other by an oil seal 18 so that these different types of oil may not be mixed together.

The reducer 2 is of a planetary gear double speed reduction mechanism of ring gear output type whereby the rotation of the output shaft 3 of the oil hydraulic motor 1 is reduced in speed and then transmitted to the output member 4 supported by the motor housing 6 via bearings 27. The reducer 2 includes a sun gear shaft 19 having its one end in splined mesh with the output shaft 3 of the variable displacement oil hydraulic motor 1 and its other end supported by the output member 4. The sun gear shaft 19 has at its leading end a first sun gear 20 in mesh with a first planetary gear 21 which in turn is meshed with a ring gear 22 formed on an inner periphery of the output member 4. Supporting the first planetary gear 21 is a gear holder 23 having a ring gear 23a formed on an inner periphery thereof. The ring gear 23a of the gear holder 23 is in mesh with a second sun gear 24 through which a mid region of the sun gear shaft 19 freely passes. A second planetary gear 25 is meshed with both the second sun gear 24 and the ring gear 22 of the output member 4 and is supported by a second planetary gear shaft 26. The gear shaft 26 is in turn supported by a carrier 28 which is in splined mesh with an outer periphery of the end wall 16 of the motor housing 6 and is thereby coupled to the latter.

In such an arrangement, feeding the pressure oil supply circuit 12 with pressure oil causes the cylinder block 8 and the output shaft 3 to rotate, and then a resulting rotation of the output shaft 3 is transmitted to the input shaft (sun gear shaft) 19 of the reducer 2, reduced by the reducer 2 and then transmitted to the output member 4, thereby rotating the drive wheels 5.

In that arrangement, causing the swash plate inclination changing piston 15 under oil pressure to protrude changes the angle of inclination of the swash plate 11 so it becomes smaller. Then, the piston 10 stroke is reduced, and the speed of rotation of the variable displacement oil hydraulic motor 1 is changed so it becomes quicker.

In such a variable displacement oil hydraulic motor or a crawler vehicle drive speed reducer using the same, an apparatus to be driven thereby imposes the requirement that its axial size be made as small as possible.

In such a variable displacement oil hydraulic motor or a crawler vehicle drive speed reducer in the prior art, however, it has been the common practice that the swash plate inclination changing piston 15 for changing the angle of inclination of the swash plate 11 is received in the end wall 16 of the motor housing 6, namely disposed in a region of the axial extension of the variable displacement oil hydraulic motor 1. As a result, the end wall 16 of the motor housing 6 must be made large (thick) in size of axial direction and so must be the oil hydraulic motor 1 at least by that extent.

JP 7-76548 B discloses a variable displacement oil hydraulic motor in which the swash plate inclination changing piston for changing the angle of inclination of the swash plate is disposed internally of the motor housing. In this known variable displacement oil hydraulic motor, the swash plate inclination changing piston is an annular member disposed between an inner peripheral surface of the motor housing and an outer peripheral surface of the cylinder block so as to encircle the cylinder block. This arrangement presents the problem that the swash plate inclination changing piston itself must be made large and calls for a large space for accommodating the same.

Also in the prior art shown in and described in connection with FIG. 7, the carrier 28 supporting the second planetary gear shaft 26 in the planetary gear double speed reduction mechanism is coupled to a outer periphery of the end of the motor housing 6, posing the requiring for a considerable length of coupling which becomes one significant factor of lengthening the axial size of the conventional variable displacement oil hydraulic motor.

Furthermore, the use of a bearing 27 of angular type in supporting the output member 4 by means of the motor housing 6 requires two such bearings facing each other in an axial direction of the motor housing 6. This requirement further makes it inevitable that the variable displacement oil hydraulic motor must become large in axial size and even in diametric size, too.

### BRIEF SUMMARY OF THE INVENTION

With the view to overcoming the problems in the prior art mentioned above, the present invention has an object aimed at providing improvements in the variable displacement oil hydraulic motor and the crawler vehicle drive speed reducer using the same, which having their internal structures improved are reduced to minimum in axial size.

In order to achieve the object mentioned above there is provided in accordance with the present invention in a primary feature thereof a variable displacement oil hydraulic motor, which comprises: a cylinder block receiving a plurality of pistons in pressure contact with a slanting surface of a swash plate variable in its angle of inclination; a motor housing accommodating the cylinder block therein; and at least one swash plate inclination changing piston which is disposed at a given circumferential position (at a given position on a circle) in an annular space defined between an outer periphery of the cylinder block and an inner periphery of the motor housing and which is movable bidirectionally in a direction parallel to the pistons to alter the in a direction parallel to the pistons to alter the angle of inclination of the swash plate.

A variable displacement oil hydraulic motor according to this feature of the present invention makes it unnecessary for any swash plate inclination changing piston for changing the angle of inclination of the swash plate to be provided in an end wall of the motor housing, thereby making it possible to make the end wall of the motor housing thinner and thus to make the variable displacement oil hydraulic motor shorter in its axial length by that extent.

And, the simple need for an aforementioned swash plate inclination changing piston supposed to be disposed only at a given circumferential position in an annular space formed between an inner periphery of the motor housing and an outer periphery of the cylinder block is sufficient to permit making the swash plate inclination changing piston itself smaller in size.

According to a second, more specific feature of the present invention, in the variable displacement oil hydraulic motor of the first form of implementation a cylinder having the swash plate inclination changing piston received therein is mounted at the given circumferential position that is displaced radially inwards from an inner peripheral surface of the motor housing into the annular space. This feature allows the swash plate inclination changing piston and the cylinder in which the piston is received to be placed in a narrow space.

According to a third feature of the present invention, there is provided a crawler vehicle drive speed reducer using a variable displacement oil hydraulic motor, which comprises the variable displacement oil hydraulic motor according to the first or second form of implementation of the invention, a planetary gear type speed reduction mechanism to which the motor housing and a motor output shaft are coupled combinatorially, and a drive wheel rotatably supported by an outer periphery of the motor housing and adapted to be rotationally driven by the variable displacement oil hydraulic motor with the intermediary of the planetary gear type speed reduction mechanism. This feature that requires the axially shortened variable displacement oil hydraulic motor to be combinatorially coupled to a planetary gear type speed reduction mechanism to form a crawler vehicle drive speed reducer allows the latter to be made smaller in axial length than the conventional one and thus to be made to stay well within the narrow width of the crawler, which has hitherto been hard to achieve.

According to a fourth feature of the present invention, the planetary gear type speed reduction mechanism according to the third feature of the invention is a planetary gear double speed reduction mechanism of ring gear output type. And, according to the fifth feature of the present invention, the planetary gear type speed reduction mechanism according to the third feature of the invention is a planetary gear double speed reduction mechanism of carrier output type. These features which require the planetary gear type speed reduction mechanism to be a planetary gear double speed reduction mechanism allow achieving an increased reduction ratio.

According to a sixth feature of the present invention, there is provided a crawler vehicle drive speed reducer using a variable displacement oil hydraulic motor according to the fourth or fifth feature of the invention, which further comprises a roller bearing for supporting the drive wheel rotatably by the outer periphery of the motor housing, wherein the roller bearing is a cross roller bearing. This feature which in contrast to an angular type bearing requires no more than one bearing allows the bearing assembly for supporting an output member of the reducer to be made shorter in axial length and makes it possible to shorten the axial length of the reducer by that extent.

According to a seventh feature of the present invention, in the crawler vehicle drive speed reducer using a variable displacement oil hydraulic motor according to the fourth feature of the invention the planetary gear type double speed reduction mechanism of gear output type includes a gear shaft for supporting a planetary gear rotatably, wherein the gear shaft is an axial extension of the end wall of the motor housing and formed monolithically therewith and of a same material of which it is formed. This feature that requires the planetary gear shaft to be formed of a material of which the motor housing is formed makes the number of component parts smaller than the conventional makeup in which the planetary gear shaft is formed separately of the motor housing while shortening the axial length of the crawler vehicle drive speed reducer.

According to an eighth feature of the present invention, in the crawler vehicle drive speed reducer using a variable displacement oil hydraulic motor according to the fourth feature of the invention a sun gear in the planetary gear double speed reduction mechanism of ring gear output type is formed monolithically with the output shaft of the variable displacement oil hydraulic motor. This feature which requires the output shaft in the motor and the sun gear shaft in the reducer to be made of a single member reduces the number of component parts by that extent and allows simplifying the support structure in a region of the sun gear in the reducer.

According to a ninth feature of the present invention, there is provided a crawler vehicle drive speed reducer which comprises in combination: a variable displacement oil hydraulic motor having a swash plate inclination changing piston according to the first or second feature and a motor housing according to the third feature of the invention; a planetary gear double speed reduction mechanism of ring gear output type according to the fourth feature of the invention; and a drive wheel held by means of a cross roller bearing according to the sixth feature of the invention. Also, according to a tenth feature of the present invention there is provided a crawler vehicle drive speed reducer which comprises in combination: a variable displacement oil hydraulic motor having a swash plate inclination changing piston according to the first or second feature and a motor housing according to the third feature of the invention; a planetary gear double speed reduction mechanism of ring gear output type according to the fourth feature of the invention; a shaft made monolithic according to the eighth feature of the invention; and a drive wheel held by means of a cross roller bearing according to the sixth feature of the invention. Further, according to an eleventh feature of the present invention there is provided a crawler vehicle drive speed reducer which comprises in combination: a variable displacement oil hydraulic motor having a swash plate inclination changing piston according to the first or second feature of the invention; a planetary gear double speed reduction mechanism of carrier output type according to the fifth feature of the invention; and a drive wheel held by means of a cross roller bearing according to the sixth feature of the invention. These features allow providing a crawler vehicle drive speed reducer with its axial size minimized.

### BRIEF DESCRIPTION OF THE DRAWINGS

These and other objects, features and advantages of the present invention and other manners of its implementation will be more readily apparent, and the invention itself will also be better understood, from the following detailed description when taken with reference to the drawings attached hereto showing certain illustrative forms of implementation of the present invention. In the drawings:

FIG. 1 is a cross sectional view illustrating a structure according to a first form of implementation of the present invention;

FIG. 2 is a cross sectional view of the structure of FIG. 1 taken along the line II-II;

FIG. 3 is a cross sectional view illustrating a structure according to a second form of implementation of the present invention;

FIG. 4 is a cross sectional view illustrating a structure according to a third form of implementation of the present invention;

FIG. 5 is a cross sectional view illustrating a structure according to a fourth form of implementation of the present invention;

FIG. 6 is a cross sectional view illustrating a structure according to a fifth form of implementation of the present invention; and

FIG. 7 is a cross sectional view of the conventional structure for variable displacement oil hydraulic motors.

### DETAILED DESCRIPTION

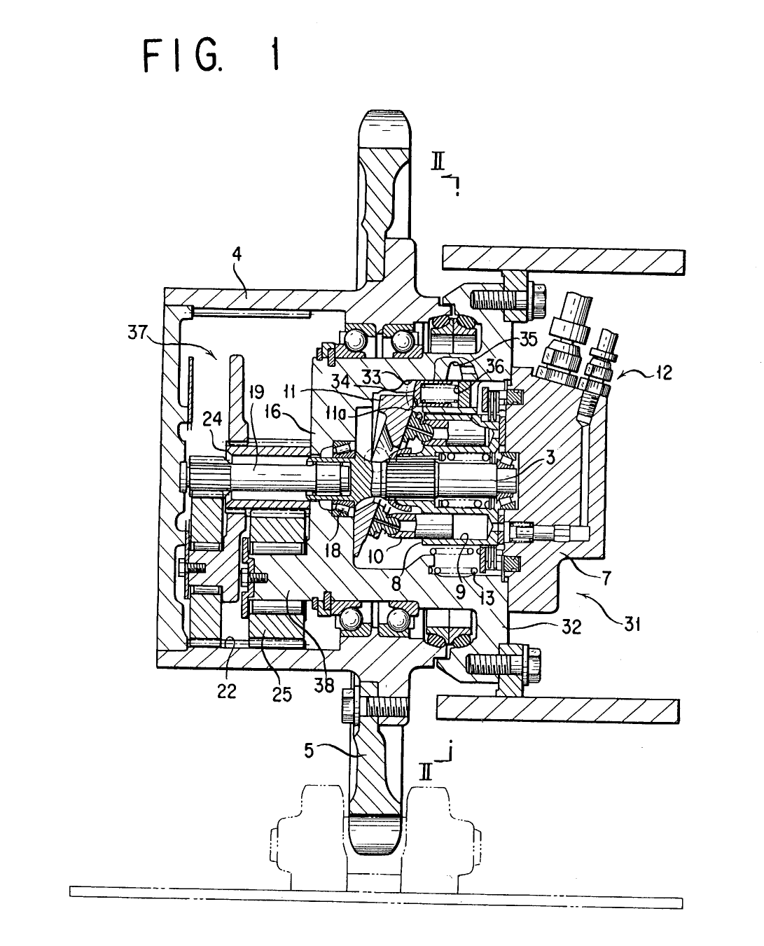

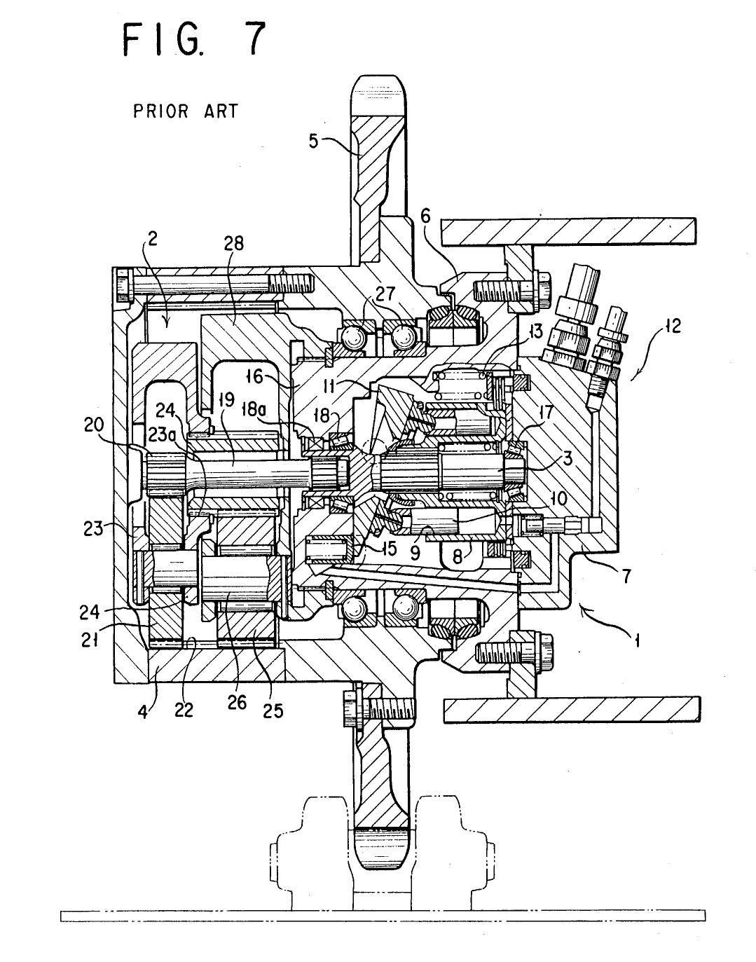

The present invention as regards its first to fifth forms of implementation will be described hereinafter with reference to FIGS. 1 to 6. In this connection, it should be noted that like reference characters used in FIG. 7 to designate components in the conventional variable displacement oil hydraulic motor 1 and the conventional crawler vehicle drive speed reducer using the same are used to designate like components in these forms of implementation. For each instance, therefore, the following discussion will omit their repeated descriptions and will be focused on differences in construction.

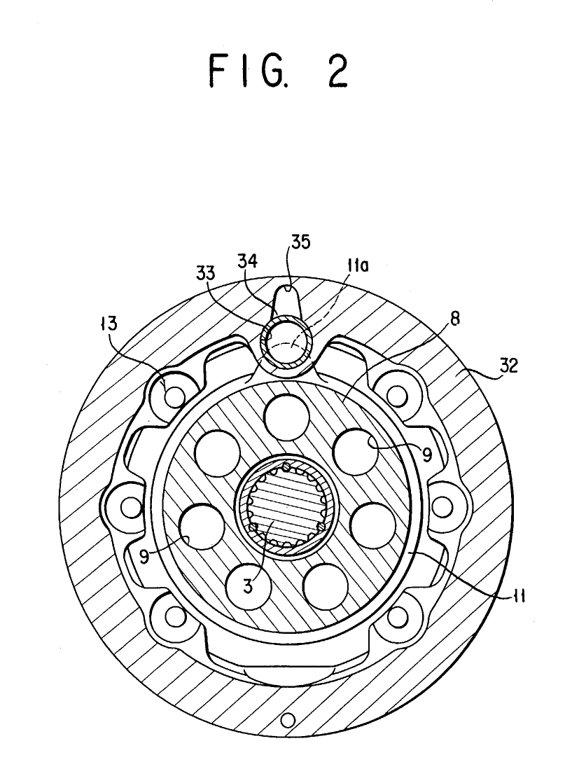

Referring now to FIGS. 1 and 2 which show the fist form of implementation of the invention, a variable displacement oil hydraulic motor 31 provides a motor housing 32 with a cylinder 33 that is disposed at a place in a circumferential direction of an annular space formed between an inner periphery of the motor housing 32 and an outer periphery of the cylinder block 8. The cylinder 33 is open facing an abutting face 11a formed as a radial extension of the swash plate 11 on its peripheral edge portion. A swash plate inclination changing piston 34 is slidably received by the cylinder 33 and is movable to bring its leading end into contact with the abutting face 11a of the swash plate 11. With the cylinder 33 mounted to extend parallel to the cylinders 9 in the cylinder block 8, the swash plate inclination changing piston 34 is movable in the cylinder 33 in a direction parallel to the pistons 10 in those cylinders 9. The innermost recess of the cylinder 33 has an oil hydraulic circuit 35 connected thereto from a pressure oil supply source via an ON/OFF switching valve (neither shown). Turning the switching valve ON to supply the oil hydraulic circuit 35 with pressure oil causes the swash plate inclination changing piston 34 to move forward to push the radial extension 11a of the swash plate 11, thereby causing the latter to swing in a direction in which the angle of its inclination becomes smaller. A spring 26 is interposed between the swash plate inclination changing piston 34 and the innermost area of the cylinder 33 to bias the swash plate inclination changing piston 34 always against the swash plate 11, thereby restraining the piston 34 from oscillating. Turning the switching valve OFF to stop supply of pressure oil into the oil hydraulic circuit 35 causes the swash plate 11 to swing back in a direction in which its angle of inclination becomes larger.

The cylinder 33 in which the swash plate inclination changing piston 34 is received is mounted as shown in FIG. 2 to protrude cylindrically from the inner peripheral surface of the motor housing 32 radially inward to an extent at which it still does not interfere with the cylinder block 8.

Also in this form of implementation, an identical type of oil may be used as the operating oil for the variable displacement oil hydraulic motor 31 and the lubricating oil for a reducer 37. This eliminates the need for the oil seal 18a required in the prior art on the end wall 16 of the motor housing 6. To wit, the end wall 16 of the motor housing 32 here is designed to allow oil to flow from the variable displacement oil hydraulic motor 31 to the reducer 37 and vice versa.

Further in this form of implementation, the reducer 37 makes use of a planetary gear double speed reduction mechanism substantially identical to that shown in FIG. 7 except that its second planetary gear shaft 38 is an axial extension of the end of the motor housing 32 and formed monolithically therewith of an identical material of which the motor housing 32 is formed.

According to this form of implementation of the invention in which the swash plate inclination changing piston 34 for changing the angle of inclination of the swash plate 11 is provided in an annular space formed between an inner periphery of the motor housing 32 and an outer periphery of the cylinder block 8, it is made no longer necessary for a space for accommodating such a swash plate inclination changing piston to be provided axially adjacent to the swash plate 11. It thus becomes possible to make the end wall 16 of the motor housing 32 thinner and thus to shorten the axial size of the variable displacement oil hydraulic motor 31 to that extent.

And, the simple need for an aforementioned swash plate inclination changing piston 34 to be disposed at a given circumferential position (at a given position on a circle) in an annular space formed between an inner periphery of the motor housing 32 and an outer periphery of the cylinder block 8 and at the position facing the abutting face 11a formed as a radial extension of the swash plate 11 is sufficient to permit making the swash plate inclination changing piston 34 itself smaller in size.

It should be noted in this connection that more than one, namely two or three such pistons 34 may be employed insofar as they are positioned to face the abutting face 11a as an radial extension of the swash plate 11.

Further in this form of implementation of the invention, forming a second planetary gear shaft 38 monolithically with the motor housing 32 and of a material of which the latter is formed makes types of components smaller in number than when the second planetary gear shaft must be prepared separately from the motor housing as in the prior art.

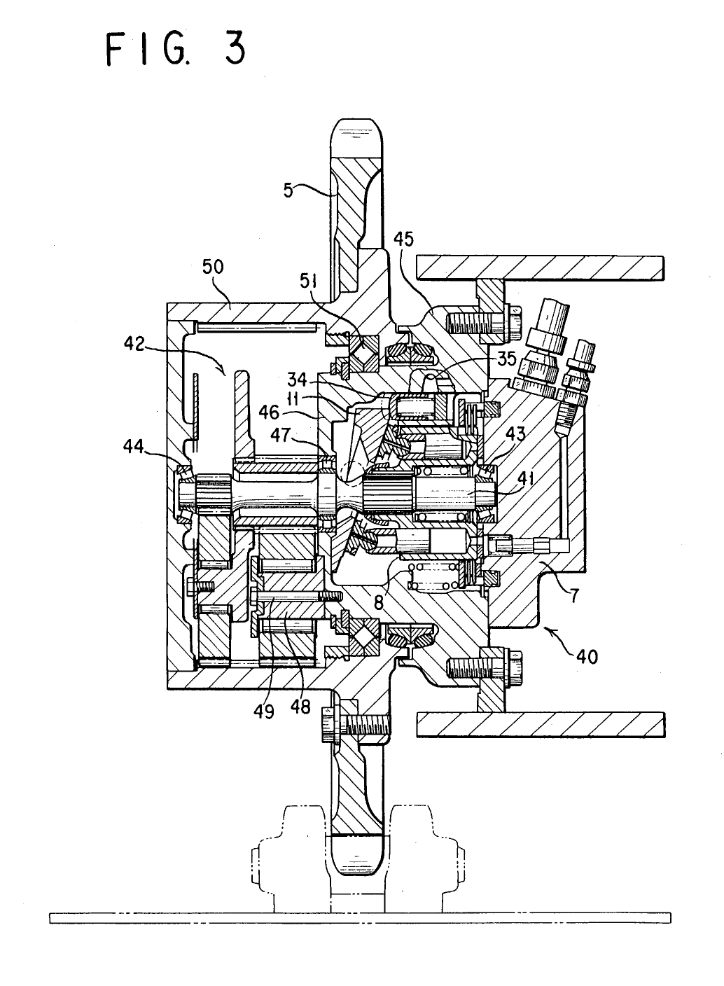

Referring next to FIG. 3 which shows a second form of implementation of the present invention, mention is made of how it differs from the prior art and the preceding first form of implementation of the invention.

A variable displacement oil hydraulic motor 40 in this form of implementation has an output shaft 41 extending into the input side of a reducer 42 wherein a part corresponding to the sun gear shaft of the reducer 37, 2 shown in FIGS. 1 and 7, respectively, is formed monolithically with this output shaft 41. The output shaft 41 has its one end supported by the cover member 7 of the variable displacement oil hydraulic motor 40 and its other end supported from the end wall of an output member 50, via tapered roller bearings 44 and 43, respectively, which are opposing to each other. The output shaft 41 passes through an end wall 46 of a motor housing 45 where it is supported by a bearing 47. Thus, the end wall 46 can be made so thin that it can only accommodate the bearing 47 and indeed be much thinner than the corresponding end wall in the aforementioned prior art where the oil seal must be provided.

Also in this form of implementation, use is made of a reducer 42 having a second planetary gear shaft 48 formed separately of the motor housing 45 and integrally fastened thereto by means of a bolt 49.

Further, the output member 50 of the reducer 42 is supported by the motor housing 45 via a cross roller bearing 51.

This form of implementation of the invention having the end wall 46 of the motor housing 45 that is only necessary to accommodate the bearing and unnecessary to provide the oil seal makes it sufficient for the end wall to have a wall thickness just enough to accommodate the bearing and hence makes the drive speed reducer using the variable displacement oil hydraulic motor smaller in axial size than when the oil seal must be provided as in the prior art.

Also, this form of implementation of the invention having the output shaft 41 of the variable displacement oil hydraulic motor 40 that is made monolithic with the sun gear shaft in the reducer 42 makes types of parts used small in number to that extent while simplifying the supporting structure of a region of the sun gear shaft in the reducer 42.

Further, this form of implementation of the invention using a cross roller bearing 51 to support the output member 50 of ring gear output type in the reducer 42 by the motor housing 45 makes such a support region smaller in axial size than when the angular axial bearing 27 must be used as in the prior art shown in FIG. 7 and as in the first form of implementation shown in FIG. 1.

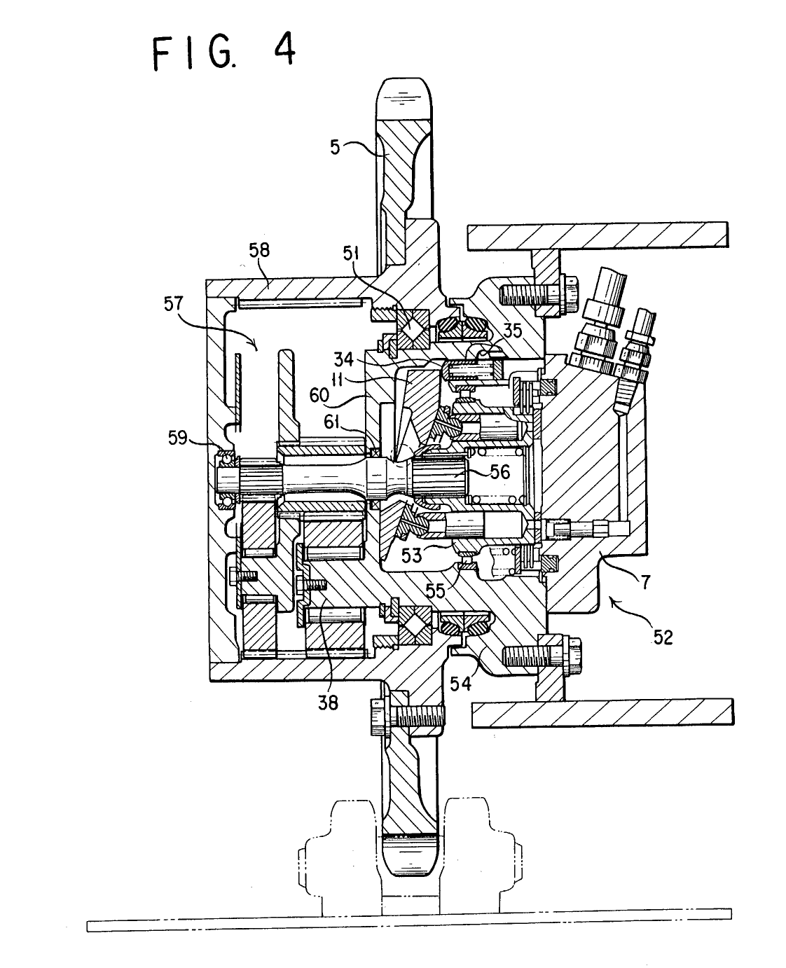

Referring next to FIG. 4 which shows a third form of implementation of the present invention, a variable displacement oil hydraulic motor 52 has a cylinder block 53 supported in the inside of a motor housing 54 via a bearing 55. Its output shaft 56 has one end coupled to the cylinder block 53 in a spline engagement therewith and the other end extending to form a sun gear shaft in a reducer 57 whose leading end is supported by an output member 58 in the reducer 57 via a bearing 59. The output shaft 56 passes through an end wall 60 of the motor housing 54 where it is provided with an oil seal 61. This oil seal 61 is dispensed with if a same type of oil is used as the operating oil for the variable hydraulic motor 52 and the lubricating oil for the reducer 57.

This form of implementation of the invention having the output shaft 56 at its one end connected to the cylinder block 53 supported by the inside of the motor housing 54 via the bearing 55 makes the output shaft itself shorter than when those must be supported by the cover member 7 as in the preceding forms of implementation of the invention while eliminating the need to provide a bearing where the output shaft 56 passes though the end wall 60.

In the third form of implementation of the invention, the second planetary gear shaft 38 is formed monolithically with the motor housing 54 and of a material of which the latter is formed, as in the first form of implementation of the invention. Also, the output member 58 of the reducer 57 is supported from the motor housing 54 via a cross roller bearing 51 as in the second form of implementation of the invention.

The third form of implementation having the output shaft 56 whose one end is connected to the cylinder block 53 supported by the motor housing 54 via the bearing 55 makes it unnecessary to support the one end of the output shaft 56 of the variable displacement oil hydraulic motor 52 via a bearing by the cover member 7 of the variable displacement oil hydraulic motor 52 via a bearing and makes it unnecessary to support the output shaft 56 by the end wall 60 of the motor housing 54 and hence makes it possible to shorten to those extents the length of the output shaft 56 of the variable displacement oil hydraulic motor 52 serving also as the sun gear shaft in the reducer 57, and further the axial length as well of the drive speed reducer using the variable displacement oil hydraulic motor 52.

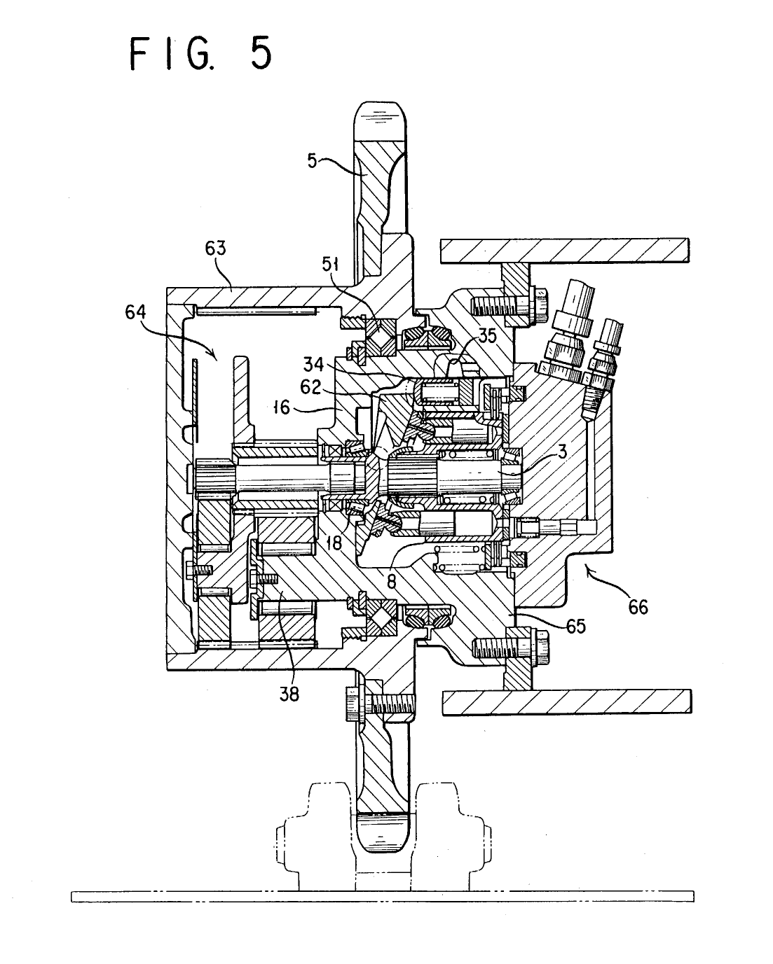

Referring next to FIG. 5, there is shown a forth form of implementation of the present invention, which is substantially identical to the first form of implementation of the invention shown in FIG. 1, with the exception of the use of a swash plate 62 that is shaped differently and an output member 63 with a different support structure in a reducer 64. The swash plate 62 has its rear surface formed with a recess in a region opposite the bearing 18, providing for a structure such that a portion of the bearing 18 enters the recess. The structure thus shortens the axial length of the drive speed reducer using the variable displacement oil hydraulic motor, to an extent corresponding to the size of this entry.

In this form of implementation, the reducer 64 adopts its support structure substantially identical to that in the third form of implementation shown in FIG. 3, wherein the output member 63 is supported from a motor housing 65 via the cross roller bearing 51.

This fourth form of implementation of the invention adopting a structure in which a variable displacement oil hydraulic motor 66 has its output shaft 3 whose other end is supported with the bearing 18 allows this bearing 18 to be located axially overlapping with the swash plate 61 and hence permits making a drive speed reducer using the variable displacement oil hydraulic valve 66 smaller in axial length by that extent.

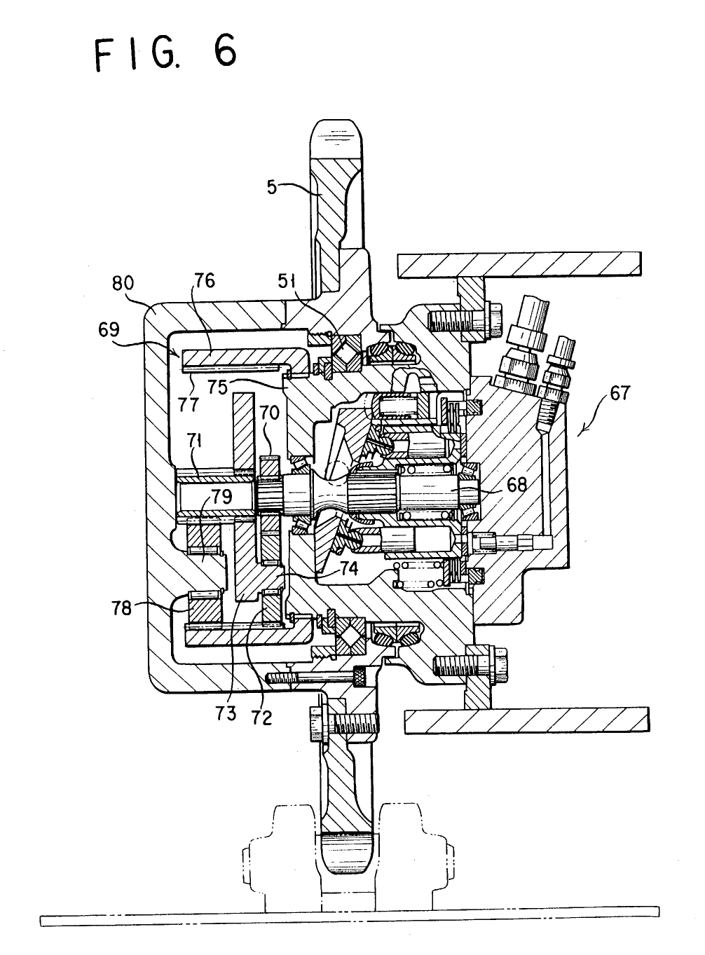

Referring next to FIG. 6, there is shown a fifth form of implementation of the present invention, in which a variable displacement oil hydraulic motor 67 that is substantially identical in makeup to that in the second form of implementation shown in FIG. 3 adopts an output shaft 68 having a reducer 69 coupled therewith which is of a planetary gear double speed reduction mechanism of carrier output type

Coupled to the variable displacement oil hydraulic motor 67 having the output shaft 68, this reducer 69 includes a first sun gear 70 provided at a leading end of the output shaft 68, a second sun gear 71 supported coaxially with the first gun gear 70, a first planetary gear 72 in mesh with the first sun gear 70, a holder 73 supported by the second sun gear 71 in splined mesh therewith, a first planetary gear shaft 74 formed monolithically with the holder 73 for supporting the first planetary gear 72, a holder 76 held in splined mesh with a motor housing 75 of the variable displacement oil hydraulic motor 67, a ring gear 77 formed on an inner surface of the holder 76 and held in mesh with the first planetary gear 72, a second planetary gear 78 held in mesh with both the second sun gear 71 and the ring gear 77, and a second planetary gear shaft 79 monolithically formed with an output member 80 for supporting the second planetary gear 78. A rotation of the output shaft 68 of the variable displacement oil hydraulic motor 67 is transmitted from the second planetary gear shaft 79 to the output member 80 via the reducer 69 using the planetary gear double speed reduction mechanism. Namely, any output whatsoever from the reducer 69 is designed to be output from the second planetary gear shaft (carrier) 79.

What is claimed is:

1. A variable displacement oil hydraulic motor comprising:
a cylinder block receiving a plurality of pistons in pressure contact with a slanting surface of a swash plate variable in its angle of inclination;
a motor housing accommodating the cylinder block therein; and
at least one swash plate inclination changing piston which is disposed at a given circumferential position in an annular space defined between an outer periphery of said cylinder block and an inner periphery of said motor housing and which is movable bidirectionally in a direction parallel to said pistons to alter the angle of inclination of said swash plate.

2. A variable displacement oil hydraulic motor as set forth in claim 1, wherein a cylinder having said swash plate inclination changing piston received therein is mounted at said given circumferential position that is displaced radially inwards from an inner peripheral surface of said motor housing into said annular space.

3. A crawler vehicle drive speed reducer using a variable displacement oil hydraulic motor, comprising the variable displacement oil hydraulic motor set forth in claim 1 or claim 2, a planetary gear type speed reduction mechanism to which said motor housing and a motor output shaft are coupled combinatorially, and a drive wheel rotatably supported by an outer periphery of said motor housing and adapted to be rotationally driven by said variable displacement oil hydraulic motor with the intermediary of said planetary gear type speed reduction mechanism.

4. A crawler vehicle drive speed reducer using a variable displacement oil hydraulic motor, as set forth in claim 3, wherein said planetary gear type speed reduction mechanism is a planetary gear double speed reduction mechanism of ring gear output type.

5. A crawler vehicle drive speed reducer using a variable displacement oil hydraulic motor, as set forth in claim 3, wherein said planetary gear type speed reduction mechanism is a planetary gear double speed reduction mechanism of carrier output type.

6. A crawler vehicle drive speed reducer using a variable displacement oil hydraulic motor, as set forth in claim 4 or claim 5, further comprising a roller bearing for supporting said drive wheel rotatably by the outer periphery of said motor housing, wherein said roller bearing is a cross roller bearing.

7. A crawler vehicle drive speed reducer using a variable displacement oil hydraulic motor, as set forth in claim 4, wherein said planetary gear type double speed reduction mechanism of gear output type includes a gear shaft for supporting a planetary gear rotatably, and said gear shaft is an axial extension of the end wall of said motor housing and formed monolithically therewith and of a same material of which it is formed.

8. A crawler vehicle drive speed reducer using a variable displacement oil hydraulic motor, as set forth in claim 4, wherein a sun gear shaft in said planetary gear double speed reduction mechanism of ring gear output type is formed monolithically with said output shaft of the variable displacement oil hydraulic motor.

9. A crawler vehicle drive speed reducer comprising in combination:
a variable displacement oil hydraulic motor having a swash plate inclination changing piston as set forth in claim 1 or claim 2 and a motor housing as set forth in claim 3;
a planetary gear double speed reduction mechanism of ring gear output type as set forth in claim 4; and
a drive wheel held by means of a cross roller bearing as set forth in claim 6.

10. A crawler vehicle drive speed reducer comprising in combination:
a variable displacement oil hydraulic motor having a swash plate inclination changing piston as set forth in claim 1 or claim 2 and a motor housing as set forth in claim 3;
a planetary gear double speed reduction mechanism of ring gear output type as set forth in claim 4;
a shaft made monolithic as set forth in claim 8; and
a drive wheel held by means of a cross roller bearing as set forth in claim 6.

11. A crawler vehicle drive speed reducer comprising in combination:
a variable displacement oil hydraulic motor having a swash plate inclination changing piston as set forth in claim 1 or claim 2;
a planetary gear double speed reduction mechanism of carrier output type as set forth in claim 5; and
a drive wheel held by means of a cross roller bearing as set forth in claim 6.
